(19) United States
(12) Patent Application Publication
(10) Pub. No.: US 2023/0005662 A1
(43) Pub. Date: Jan. 5, 2023

(54) PORTABLE PLASMA DEVICE WITH ADJUSTABLE DISCHARGE VOLTAGE

(71) Applicant: FEMTO SCIENCE INC, Hwaseong-si (KR)

(72) Inventors: Moo Hwan KIM, Hwaseong-si (KR); Yeon Sook CHANG, Hwaseong-si (KR)

(73) Assignee: FEMTO SCIENCE INC, Hwaseong-si (KR)

(21) Appl. No.: 17/502,823

(22) Filed: Oct. 15, 2021

(30) Foreign Application Priority Data
Jun. 30, 2021 (KR) 10-2021-0086025

(51) Int. Cl. H01F 38/26; H01F 5/02

(52) U.S. Cl. CPC H01F 38/26; H01F 5/02; H01F 2005/022

(57) ABSTRACT

A secondary bobbin of a high-voltage transformer and a portable plasma device including the same are provided to regulate discharge voltage. The secondary bobbin of the high-voltage transformer includes: a main body; barrier portions dividing the main body into a predetermined number of multiple segments along the length of the main body; winding portions where a coil is wound on the multiple segments into which the main body is divided; and switch circuit portions connecting neighboring barrier portions by a switch, wherein the switch circuit portions electrically connect or disconnect the winding portions to adjust the number of turns depending on whether the switch circuit portions are on or off.

### CROSS REFERENCE TO RELATED APPLICATION

The present application claims priority to Korean Patent Application No. 10-2021-0086025, filed on Jun. 30, 2021, which is hereby incorporated by reference in its entirety.

### BACKGROUND

The present disclosure relates to a secondary bobbin of a high-voltage transformer that allows optimum adjustment of discharge voltage depending on the type of introduced gas and a portable plasma device including the secondary bobbin of the high-voltage transformer.

In general, transformers are devices used for increasing or decreasing applied AC voltages, where a core is inserted and mounted into a hollow portion formed inside a bobbin made of resin, and a primary coil and a secondary coil are wound around the bobbin. The primary coil is connected to an input circuit in which voltage is to be transformed, and the secondary coil is connected to an output circuit in which the transformed voltage is used.

More specifically, when an AC current of the input circuit passes through the primary coil, a magnetic flux whose strength and direction varies is generated in response to the AC current. A change of the magnetic flux induces an AC voltage in the secondary coil, and the turn ratio of the primary and secondary coils determines a voltage transformation ratio. The transformer is used in various types of electronic devices—for example, liquid crystal displays (LCD), flat panel displays (FPD), plasma display panels (PDP), printers, and so on.

For example, the transformer is configured by including a bobbin made of resin around which the primary coil and the secondary coil are wound, an inner core inserted into the bobbin, and a cover core covering the bobbin. A primary coil terminal is placed on one side of the bobbin to electrically connect the input circuit and the primary coil, and a secondary coil terminal is placed on the other side of the bobbin to electrically connect the output circuit and the secondary coil.

The bobbin, which is made of resin as mentioned above, is made by plastic injection molding according to design conditions so that a hollow portion for mounting the inner core is formed inside, where the coils are wound around the bobbin and the inner core is inserted and fixed to the hollow portion of the bobbin.

Accordingly, when an AC current of the input circuit passes through the primary coil, a change in current flowing through the primary coil produces a magnetic flux change in the inner core, an induced current flows through the secondary coil by a magnetic flux created in the inner core, and the induced current flowing through the secondary coil is provided to the output circuit. In this instance, the cover core prevents outward leakage of magnetic flux by enclosing the magnetic flux created in the inner core.

### SUMMARY

However, the above conventional technology is problematic in that it cannot cope with optimum discharge voltage which varies with gases, because the number of turns in a coil wound on a secondary bobbin is constant.

In view of this, the present disclosure is directed to provide a portable plasma device in which a switch circuit is added and attached to a secondary bobbin of a high-voltage transformer, which can apply optimum discharge voltage depending on the type of gas introduced into the plasma device since the number of turns on the secondary bobbin can be adjusted according to the on or off state of the switch, and can therefore improve plasma generation efficiency.

The present disclosure provides a secondary bobbin of a high-voltage transformer including: a main body; barrier portions dividing the main body into a predetermined number of multiple segments along the length of the main body; winding portions where a coil is wound on the multiple segments; and a plurality of switch circuit portions connecting neighboring barrier portions by a switch, wherein the number of turns is adjusted depending on whether the switch is on or off.

The switch circuit portions may include single pole double throw (SPDT) switches.

The thickness of each of the barrier portions may be determined by the average number of turns calculated by the following equation:

Average number of turns=Sum of the numbers of turns on both sides of barrier portion/2

The switch circuit portions may be individually switched on or off.

When a switch circuit portion is switched on, neighboring winding portions connected to the switched-on switch circuit portion may be electrically connected through a circuit.

The plurality of switch circuit portions may be sequentially switched on or off along the length of the main body.

Another exemplary embodiment of the present disclosure provides a portable plasma device including: a handset comprising a discharge voltage regulator, a secondary bobbin of a high-voltage transformer, and an electrode assembly; and a power supply supplying power to the handset, wherein the electrode assembly generates plasma by receiving a discharge voltage of the secondary bobbin of the high-voltage transformer, the secondary bobbin of the high-voltage transformer comprising: a main body; barrier portions dividing the main body into a predetermined number of multiple segments along the length of the main body, winding portions where a coil is wound on the multiple segments; and a plurality of switch circuit portions connecting neighboring barrier portions by a switch, wherein the switch circuit portions regulate discharge voltage depending on whether the switch circuit portions are switched on or off, and the discharge voltage regulator regulates a discharge voltage of the secondary bobbin of the high-voltage transformer by operating the switch circuit portions.

The switch circuit portions may include single pole double throw (SPDT) switches.

The thickness of each of the barrier portions may be determined by the average number of turns calculated by the following equation:

Average number of turns=Sum of the numbers of turns on both sides of barrier portion/2

When a switch circuit portion is switched on, neighboring winding portions connected to the switched-on switch circuit portion may be electrically connected through a circuit.

The plurality of switch circuit portions may be sequentially switched on or off along the length of the main body.

### BRIEF DESCRIPTION OF THE DRAWINGS

FIG. 1 schematically shows a configuration of a secondary bobbin of a high-voltage transformer according to an embodiment of the present disclosure.

FIG. 2 is an enlarged view of a switch circuit portion's position depending on the on or off state of a switch according to the present disclosure.

FIG. 3 shows how the thickness of barrier portions of the secondary bobbin of the high-voltage transformer varies with the average number of turns according to the present disclosure.

FIG. 4 shows a schematic configuration of a portable plasma device with adjustable discharge voltage.

### DETAILED DESCRIPTION

As the disclosure allows for various changes and numerous embodiments, particular embodiments will be illustrated in the drawings and described in detail. However, it should be understood that the present disclosure is not limited to particular modes of practice, but encompasses all changes, equivalents, and substitutes included in the technical spirit and technical scope to be described below.

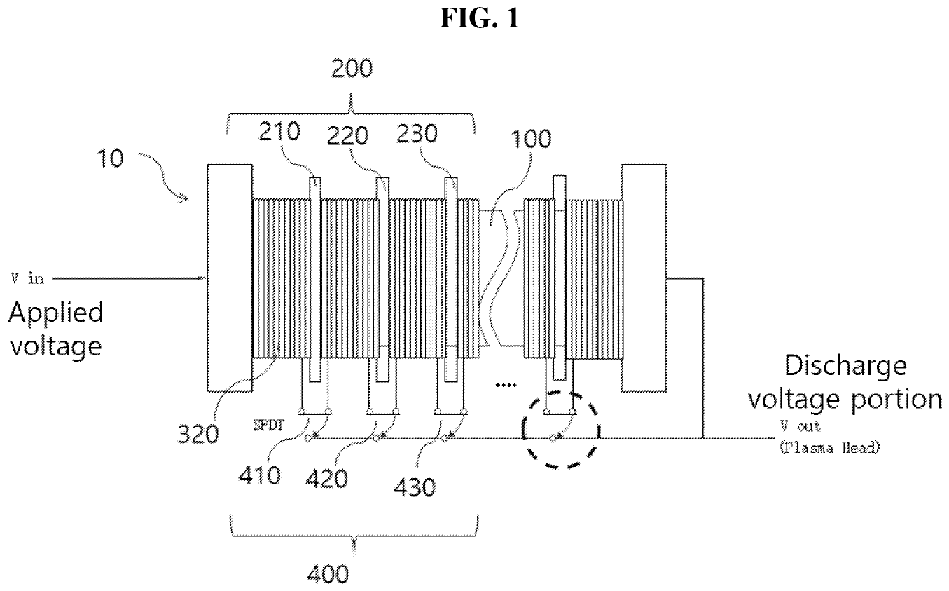

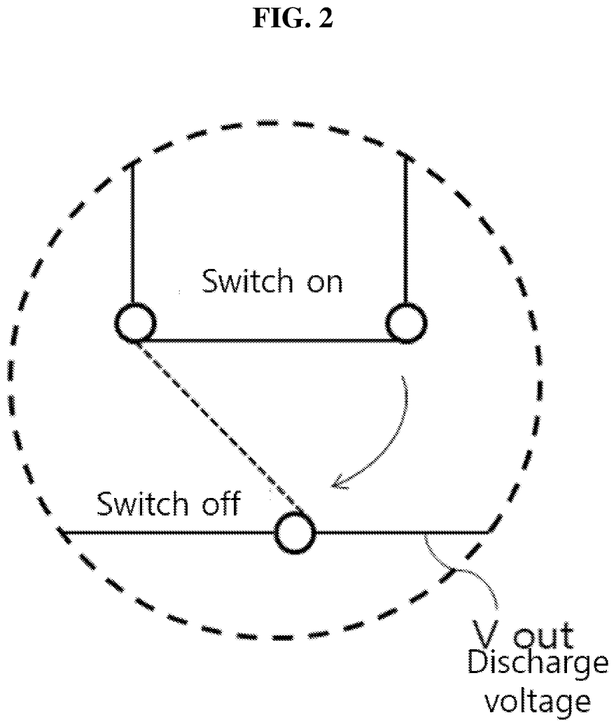

FIGS. 1 and 2 schematically depict a configuration of a secondary bobbin 10 of a high-voltage transformer according to an embodiment of the present disclosure. Referring to FIGS. 1 and 2, the secondary bobbin 10 of the high-voltage transformer may include a main body 100, barrier portions 200, winding portions 300, and switch circuit portions 400.

The main body 100 has a predetermined length and may have a secondary coil wound on the outer circumference. A core insertion hole 110 through which a core is inserted and passes may be formed at an inner center of the main body 100.

The core insertion hole 110 may be formed in such a way that it penetrates the center along the length of the main body 100. The shape of a cross-section of the core insertion hole 110 may correspond to the shape of a cross-section of the core inserted into the core insertion hole 110, examples of which include, but not limited to, circular, rectangular, and polygonal.

An inside wall of the core insertion hole 110 may be coated with an insulating material so that the core inserted into the core insertion hole 110 and the coil wound on the main body 100 are kept insulated from each other.

A plurality of barrier portions 200 may be placed at predetermined intervals along the length of the main body 100, and may divide the main body 100 into multiple segments and be formed along the outer circumference of the main body 100.

The barrier portions 200 may be spaced at equal distances or at predetermined distances.

The spacing distance between each of the plurality of barrier portions 200 may be predetermined so that the secondary bobbin 10 of the high-voltage transformer generates and applies an optimum discharge voltage which varies for different types of gases introduced into the plasma device.

The barrier portions 200 each may have a thickness of 0.3 mm to 5 mm. A barrier portion thickness less than 0.3 mm may shorten the distance between the windings of the secondary coil wound on each segment of the outer circumference, and this may lead to insufficient electrical insulation. With a barrier portion thickness more than 5 mm, the secondary coil may not have enough windings to accommodate the thickness of the barrier portions 200 by comparison to its insulation effect. Thus, the thickness of the barrier portions 200 may not exceed 5 mm.

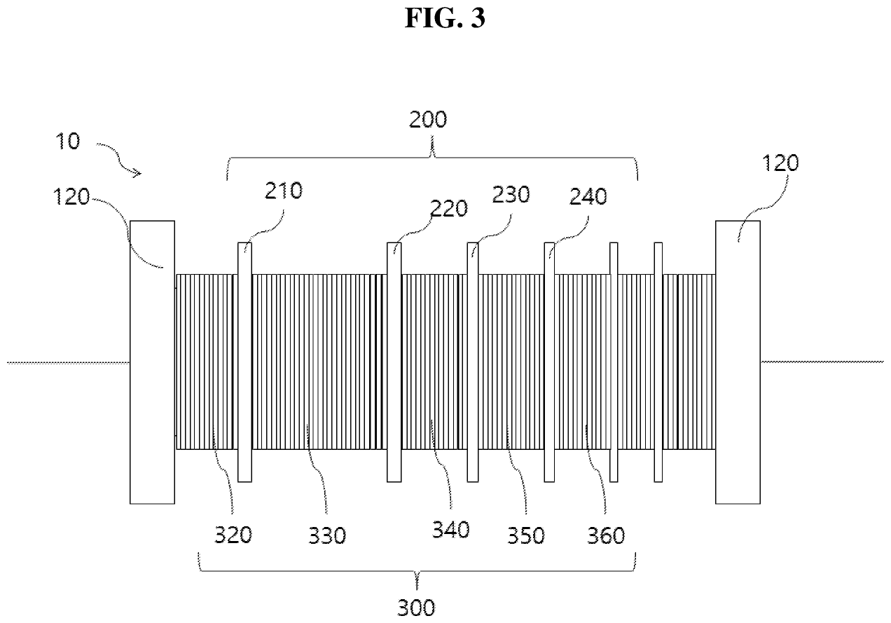

Referring to FIG. 3, the thickness of the barrier portions 200 may vary with the number of turns on the winding portions 300 wound on both sides of each of the barrier portions 200. That is, the thickness of each of the barrier portions 200 may be proportional to the average number of turns between two winding portions 300 placed on both sides of the barrier portion 200. As the number of turns in a coil wound on a winding portion 300 increases, the voltage applied in the winding portion 300 increases, which may cause damage to the secondary bobbin 10 due to the voltage. Accordingly, it is important that the barrier portions 200 prevent damage to the secondary bobbin 10 by providing sufficient insulation between the winding portions 300. As such, the thickness of each of the barrier portions 200 may be determined in such a way as not to cause damage to the secondary bobbin 10. The average number (S) of turns may be calculated by the following equation.

Average number of turns=Sum of the numbers of turns on both sides of barrier portion/2

A guard 120 may be formed on both ends of the main body 100. The guard 120 may be made thicker than the barrier portions 200 and taller than the barrier portions 200.

The main body 100 and barrier portions 200 of the secondary bobbin 10 may be manufactured in such a way that the main body 100 and the barrier portions 200 are incorporated into a single unit by injection molding, or in such a way that the main body 100 and the barrier portions 200 are molded separately and then joined and attached later on.

The barrier portions 200 may include a first barrier portion 200, a second barrier portion 220, a third barrier portion 230, . . . an Nth barrier portion which are placed sequentially from one end of the secondary bobbin 10 to the other end.

The barrier portions 200 may divide the main body 100 into multiple segments, and a plurality of winding portions 300 on which the secondary coil 310 is wound may be placed in the multiple segments into which the main body 100 is divided.

The plurality of winding portions 300 may include a first winding portion 320, a second winding portion 330, a third winding portion 340, . . . an Nth winding portion which are placed sequentially from one end of the secondary bobbin 10 to the other end.

The switch circuit portions 400 are used for regulating discharge voltage by adjusting the number of turns in a coil wound on the secondary bobbin 10, and may connect an (N−1)th winding portion 300 and its neighboring Nth winding portion 300 by a switch.

The switch circuit portions 400 may electrically connect the winding portions 300 and an electrode assembly to regulate a discharge voltage generated in the secondary bobbin 10 and apply the discharge voltage to the electrode assembly. The switches of the switch circuit portions 400 may be, but not limited to, single pole double throw (SPDT) switches, for example.

Each of the switch circuit portions 400 is a circuit that connects a winding portion 300 and its neighboring winding portion 300 by a switch. The switch circuit portions 400 may include a first switch circuit 410 connecting the first winding portion 320 and the second winding portion 330, a second switch circuit 420 connecting the second winding portion 330 and the third winding portion 340, a third switch circuit 430 connecting the third winding portion 340 and a fourth winding portion 350, . . . , an Nth switch circuit connecting an Nth winding portion and an (N+1)th winding portion, from one end of the secondary bobbin 10 to the other end.

In the switch circuit portions 400, when the switch of a switch circuit is in the ON position, the corresponding winding portions neighboring each other may be electrically connected, and, when the switch of the switch circuit is in the OFF position, the corresponding winding portions neighboring each other may be electrically disconnected, and the switch may be electrically connected to a discharge voltage portion.

The plurality of switch circuits of the switch circuit portions 400 may be sequentially placed in the ON/OFF position, from one end of the main body 100 to the other end along the length.

For example, when the switches of the first switch circuit 410 and the second switch circuit 420 are in the ON position, the switches of the third switch circuit 430 to Nth switch circuit may be placed in the OFF position, a discharge voltage may be determined by the total number of turns on the first winding portion 320, the second winding portion 330, and the third winding portion 340 electrically connected by the first switch circuit 410 and the second switch circuit 420, and the determined discharge voltage may be applied to the electrode assembly. In this case, since the switch of the third switch circuit 430 is in the OFF position, the third winding portion 340 may be connected to the discharge voltage portion. When all the switch circuits of the switch circuit portions 400 are in the ON position, the total number of turns on the secondary bobbin 10 reaches a maximum and therefore the discharge voltage also reaches a maximum and may be applied to the electrode assembly. When all the switch circuits of the switch circuit portions 400 are in the OFF position, the first winding portion 320 and the second winding portion 330 are electrically disconnected and therefore a discharge voltage of 0 V may be applied to the electrode assembly.

The switch circuit portions 400 may be a component for adjusting the total number of turns on the winding portions 300. Various types of gases may be introduced into the portable plasma device 20 according to the present disclosure, and, since different optimum discharge voltages are required for different types of gases, the portable plasma device 20 is configured to regulate discharge voltage depending on the type of gas by having the high-voltage transformer's secondary bobbin 10 attached to the inside to regulate discharge voltage.

The plurality of barrier portions 200 may be formed, and the main body 100 may be divided into multiple segments, with a coil wound on each of the segments. The number of turns per unit length for each segment may be predetermined depending on the type of gas to be introduced.

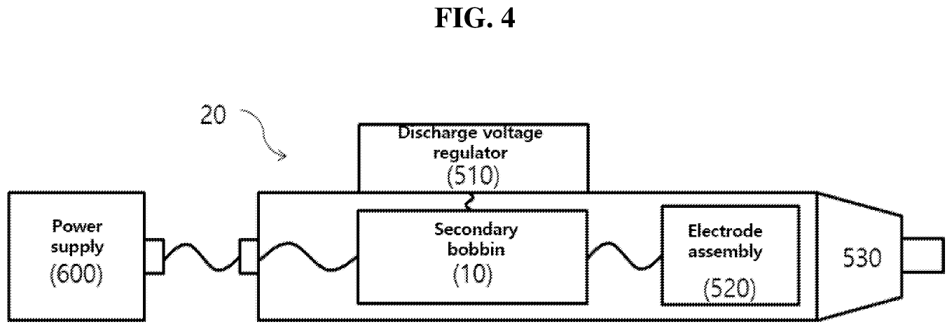

Referring to FIG. 4, the plasma device 20 according to the present disclosure is a portable-sized device for generating and emitting plasma, and may be connected to a power supply 600 to receive power.

The secondary bobbin 10 of the transformer according to the present disclosure may be included inside the portable plasma device 20, and the secondary bobbin 10 may secondarily regulate voltage depending on the type of gas introduced into the plasma device 20 when a primary voltage is applied to the portable plasma device 20 from the power supply 600. Since the secondary bobbin 10 applies a different discharge voltage depending on the type of gas, the electrode assembly may generate plasma with optimum discharge voltage, thereby improving plasma generation efficiency.

The portable plasma device 20 may include a discharge voltage regulator 510, a secondary bobbin 10 of a high-voltage transformer, an electrode assembly 520, and a plasma head 530.

The discharge voltage regulator 510 may be a component for regulating the discharge voltage of the portable plasma device 20. The discharge voltage regulator 510 may be connected to the switch circuit portions 400, and when the user manipulates the discharge voltage regulator 510, the on/off position of the switches of the switch circuit portions 400 are controlled and therefore the discharge voltage may be regulated by adjusting the number of turns on the secondary bobbin 10.

The discharge voltage regulator 510 may be provided in the plasma device 20, and may include, but not limited to, dial control type, sliding control type, and button control type, for example.

The electrode assembly 520 may be a component for generating plasma by receiving a discharge voltage from the secondary bobbin 10.

The plasma head 530 may be a component for guiding the plasma generated in the electrode assembly 520 to release it out of the plasma device 10.

The power supply 600 may be a component for supplying primary power to the portable plasma device 20. A voltage applied to the portable plasma device 20 may be varied depending on the type of gas introduced into the plasma device 20 and provided to the electrode assembly by manipulating the discharge voltage regulator 510.

While the present technology has been described in the foregoing with reference to an embodiment, the technology is by no means limited to the embodiment. The embodiment may be modified and altered without departing from the gist and scope of the technology, and those skilled in the art will appreciate that such modifications and alterations fall within the scope of the present technology.

The portable plasma device with adjustable discharge voltage allows adjustment of the number of turns depending on the type of introduced gas and therefore optimally regulates plasma discharge voltage, by including a secondary bobbin of a transformer capable of adjusting discharge voltage by adjusting the number of turns.

What is claimed is:

1. A secondary bobbin of a high-voltage transformer comprising:
a main body;
barrier portions dividing the main body into a predetermined number of multiple segments along the length of the main body;
winding portions where a coil is wound on the multiple segments; and
a plurality of switch circuit portions connecting neighboring barrier portions by a switch,
wherein the number of turns is adjusted depending on whether the switch is on or off.

2. The secondary bobbin of claim 1, wherein the switch circuit portions comprise single pole double throw (SPDT) switches.

3. The secondary bobbin of claim 1, wherein the thickness of each of the barrier portions is determined by the average number of turns calculated by the following equation:
Average number of turns=Sum of the numbers of turns on both sides of barrier portion/2.

4. The secondary bobbin of claim 1, wherein the switch circuit portions are individually switched on or off.

5. The secondary bobbin of claim 1, wherein, when a switch circuit portion is switched on, neighboring winding portions connected to the switched-on switch circuit portion are electrically connected through a circuit.

6. The secondary bobbin of claim 5, wherein the plurality of switch circuit portions are sequentially switched on or off along the length of the main body.

7. A portable plasma device comprising:
a handset comprising a discharge voltage regulator, a secondary bobbin of a high-voltage transformer, and an electrode assembly; and
a power supply supplying power to the handset,
wherein the electrode assembly generates plasma by receiving a discharge voltage of the secondary bobbin of the high-voltage transformer,
the secondary bobbin of the high-voltage transformer comprising:
a main body;
barrier portions dividing the main body into a predetermined number of multiple segments along the length of the main body,
winding portions where a coil is wound on the multiple segments; and
a plurality of switch circuit portions connecting neighboring barrier portions by a switch,
wherein the switch circuit portions regulate discharge voltage depending on whether the switch circuit portions are switched on or off, and the discharge voltage regulator regulates a discharge voltage of the secondary bobbin of the high-voltage transformer by operating the switch circuit portions.

8. The portable plasma device of claim 7, wherein the switch circuit portions comprise single pole double throw (SPDT) switches.

9. The portable plasma device of claim 7, wherein the thickness of each of the barrier portions is determined by the average number of turns calculated by the following equation:
Average number of turns=Sum of the numbers of turns on both sides of barrier portion/2.

10. The portable plasma device of claim 7, wherein, when a switch circuit portion is switched on, neighboring winding portions connected to the switched-on switch circuit portion are electrically connected through a circuit.

11. The portable plasma device of claim 10, wherein the plurality of switch circuit portions are sequentially switched on or off along the length of the main body.
